(19) United States
(12) Patent Application Publication
(10) Pub. No.: US 2017/0062201 A1
(43) Pub. Date: Mar. 2, 2017

(54) INSULATION-FREE LEAD WIRES FOR COMPACT FLUORESCENT LAMPS

(71) Applicant: General Electric Company, Schenectady, NY (US)

(72) Inventors: Rita CSIRMAZ, Budapest (HU); Sandor LUKACS, Veröce (HU); Laszlo BANKUTI, Budapest (HU); Jacint GERGELY, Budapest (HU); Lorand Lehel TOTH, Budapest (HU)

(21) Appl. No.: 14/869,209

(22) Filed: Sep. 29, 2015

Related U.S. Application Data
(60) Provisional application No. 62/213,093, filed on Sep. 1, 2015.

(51) Int. Cl. H01J 61/36; H01J 61/56; H01J 9/28; H01J 61/32

(52) U.S. Cl. CPC H01J 61/36; H01J 61/327; H01J 61/56; H01J 9/28

(57) ABSTRACT

Devices and methods relating to insulation-free lead wires in compact fluorescent lamps are provided. For example, there is provided a compact fluorescent lamp including at least two lead wires. Each of the lead wires can be connected to a respective cathode of a respective discharge tube. The compact fluorescent lamp further includes a ballast circuit. The lead wires are isolated from one another without any insulation.

### CROSS-REFERENCE TO RELATED APPLICATION

The present application claims priority from U.S. Provisional Patent Application No. 62/213,093, filed on Sep. 1, 2015, the content of which is incorporated herein in its entirety.

### TECHNICAL FIELD

The present disclosure generally relates to compact fluorescent lamps. More particularly, the present disclosure relates to devices and methods for providing insulation-free lead wires in compact fluorescent lamps.

### BACKGROUND

Compact fluorescent lamps have enjoyed widespread use as an alternative to incandescent lamps because they consume less power and last longer, thereby providing consumers increased value. Furthermore, current trends in the energy market indicate that consumers are now more cognizant of energy savings due to the advent of Internet-connected applications and hardware capable of providing real-time monitoring and energy consumption management capability. As such, compact fluorescent lamps are slated to gain further importance as the lighting apparatuses of choice in many commercial and residential applications.

Typical compact fluorescent lamps include at least one discharge tube equipped with a lead wire for energizing its cathode. Further, they may also include a ballast circuit necessary for operating the lamp; this ballast circuit may be placed in a housing configured to hold the various components of the lamps, wherein the housing also serves as a means for connecting or screwing the lamp into a base, much like one would do with a light bulb.

Due to the close proximity of all the components located in the housing, a lead wire is typically insulated in order to prevent it from creating a short circuit with unwanted components of the ballast circuit. Furthermore, as is often the case, there may be more than one discharge tube, meaning that there may be a plurality of lead wires within the housing, which also means that the lead wires have to be isolated from one another.

Therefore, in typical compact fluorescent lamps, insulating layers are provided around and between the wires, in order to prevent short circuits that can adversely affect the lamps. This requirement increases design complexity. Furthermore, from a manufacturer's perspective, the requirement for insulation increases the average cost of a lamp.

### SUMMARY

The embodiments featured herein help solve or mitigate the above-noted issues as well as other issues known in the art. Specifically, the exemplary embodiments provide a means for circumventing the need for insulation.

In some embodiments, a plastic collar design is used, as shall be discussed below. The collar is slotted and the lead wires coming from the cathodes are positioned and kept away from each other by hooking them tightly into barbed slots. The end of the wires are wrapped on wire holders (or posts) placed on a printed circuit board disposed overtop the collar.

In one embodiment, there is provided a compact fluorescent lamp that includes a lead wire connected at one end to a cathode of a discharge tube. The compact fluorescent lamp includes a collar including a slot. Furthermore, the compact fluorescent lamp can include a printed circuit board including a ballast circuit and a post. The lead wire is hooked through the slot and secured on the post.

In another embodiment, there is provided a method of isolating a lead wire connected at one end to a discharge tube disposed in a compact fluorescent lamp. The method can include passing the lead wire through a slot of a collar structure configured to support a printed-circuit board. The printed circuit board includes a post disposed thereon. The method can further include securing the lead wire to the post.

In yet another embodiment, there is provided a compact fluorescent lamp including at least two lead wires. Each of the lead wires can be connected to a respective cathode of a respective discharge tube. The compact fluorescent lamp further includes a ballast circuit. Furthermore, the at least two lead wires are isolated from one another without any insulation.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an illustration of a portion of an insulation-free compact fluorescent lamp, according to an embodiment.

FIG. 2 is a side view of an insulation-free compact fluorescent lamp, according to an embodiment.

FIG. 3 is an illustration of a slotted collar, according to an embodiment.

FIG. 4 is a flow chart of an exemplary method of practicing an embodiment of the present invention.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

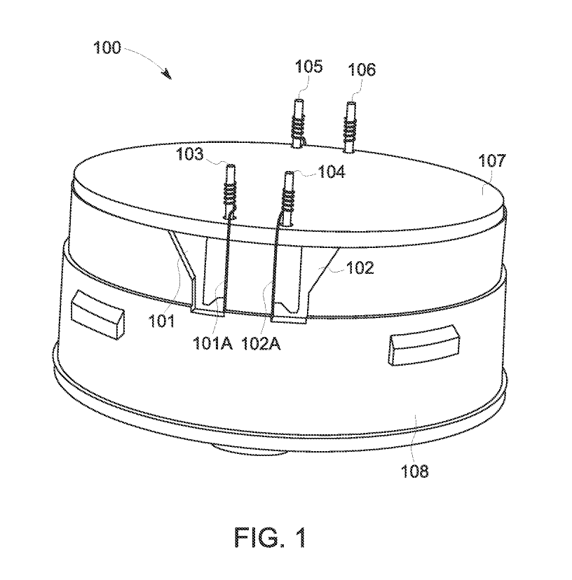

FIG. 1 is an illustration of a portion of an insulation-free compact fluorescent lamp 100, according to an embodiment. Lamp 100 includes a collar 108 that includes a plurality of slots (of which slot 101 and 102 are shown). Each slot is dedicated for a lead wire originating from a cathode of a discharge tube. For example, slot 101 corresponds to wire 101a and slot 102 corresponds to wire 102a. The slots are essentially an indentation in the structure of the collar. While any particular shape of indentation is contemplated, one requirement for a slot is a recessed portion that can serve as hook to guide the lead wire from inside collar 108 to the outside of collar 108. Once a lead wire is guided outside through the slot, it is secured onto a post that is disposed on a printed circuit board.

For example, wire 101a is guided from inside collar 108 to the outside of collar 108 via the recessed portion of slot 101. Once outside, wire 101 is guided to a post 103 that is disposed on printed circuit board 107 and it is tightly wrapped around post 103 to secure it. In some embodiments, post 103 can be made of plastic, in which case the end of wire 101a must be connected electrically to a circuit on printed circuit board 107, the circuit being configured to energize the cathode to which wire 101a is connected. In other embodiments, however, post 103 can be a metallic structure that is soldered (or attached by any other means) to a trace of printed circuit board 107. In these embodiments, merely wrapping wire 101a around post 103 provides electrical connectivity to the cathode to which wire 101a is connected.

The same considerations discussed above with respect to wire 101a apply for wires 102a, 105a, and 106a, which are secured by posts 104, 105, and 106 respectively.

While only four lead wires are shown, one of ordinary skill in the art will readily appreciate that lamp portion 100 can have fewer or more than four wires, wherein each wire is guided through one slot and secured with one post on printed circuit board 107.

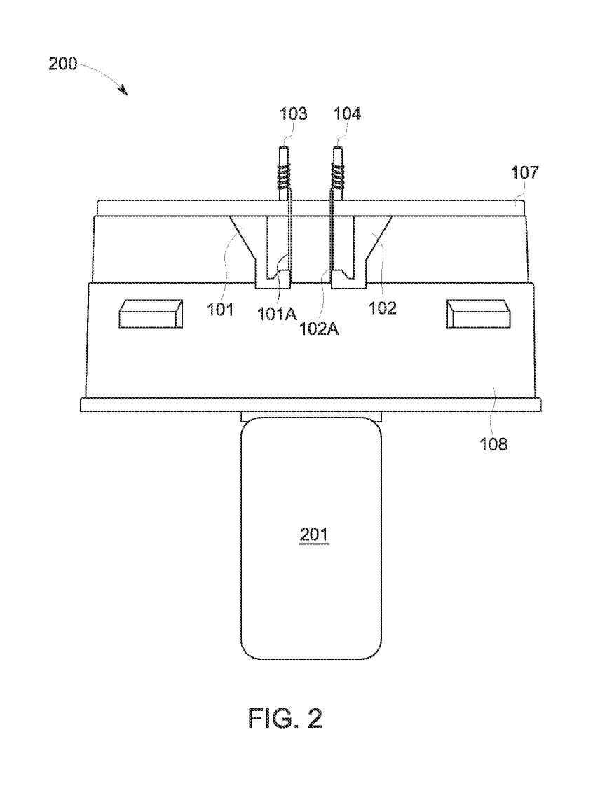

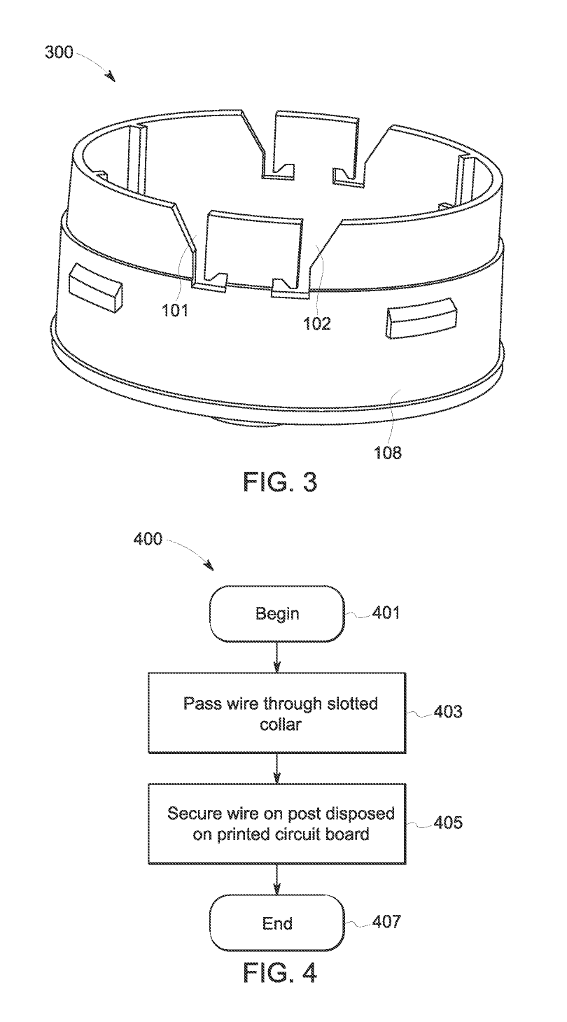

FIG. 2 is a side view illustration 200 of lamp portion 100. A discharge tube 201 is shown for clarity. As stated above, a wire attached to a cathode of the tube 201 goes inside collar 108, comes out through a recessed portion of a slot and secured on a post disposed on printed circuit board 107. Once all wires are secured, lamp portion 100 can be attached to a housing (not shown) that protects printed circuit board 107. An illustration of collar 108 on its own is shown in FIG. 3, for clarity. It is noted that collar 108 can be me made of plastic or any other material that does not conduct electricity. In some embodiments, collar 108 can be made partly of metallic material and the parts of collar 108 contact the lead wires can be made of a dielectric material.

FIG. 4. is an illustration of a method 400 according to an embodiment. Method 400 is a process for isolating lead wires in a compact fluorescent lamp assembly. Method 400 begins at block 401, and it can include a step 403 of passing a lead wire from inside a collar structure of the lamp assembly to outside the collar structure. The lead wire is passed via a slot machined or formed into the collar structure. More specifically, the lead wire is passed via a recessed portion of the slot. Once the lead wire is outside the collar structure, it is secured on post disposed on top of a printed circuit board. (Step 405). Securing the lead wire on the post can include wrapping the wire around the post. However, in some embodiments, any means of securing the wire can be used. For example, the wire can be secured to the post with a tie or a clamp. Furthermore, the method can include a step (not shown) of connecting the lead wire to a trace of the printed circuit board. Method 400 ends at step 407.

The embodiments described herein provide means for isolating lead wires without using additional components, such as insulating layers, as is done in the related art. Therefore, the embodiments resolve the issue of potentially having short circuits caused by the lead wires contacting one another or the ballast circuit (i.e. a circuit on printed circuit board 107 that is configured to operate the lamp). In the embodiments, however, the insulation is performed using no additional components, as would be done in the related art.

According to the present disclosure, a compact fluorescent lamp can include a lead wire originating from a cathode of a discharge tube, a collar including a slot, and a printed circuit board including a ballast circuit and a post mounted thereon; the lead wire is then routed from inside the collar to outside the collar and secured on the post. As such, in the exemplary compact fluorescent lamp, the lead wire is isolated from the ballast circuit without any insulation, wherein insulation is considered herein to be any dielectric material other than air. Further, while it is disclosed herein that a lead wire is connected to a cathode of the discharge tube, generally speaking, the lead wire can be connected to any component of the compact fluorescent lamp, or to any electrically active portion of the discharge tube, depending on the lamp's configuration.

The exemplary compact fluorescent lamp can also include additional lead wires having their dedicated slots and posts, in which case the lead wires are isolated from one another and from the ballast circuit without any insulation.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A compact fluorescent lamp, comprising:
a lead wire originating from a cathode of a discharge tube;
a collar including a slot; and
a printed circuit board including (i) a ballast circuit and (ii) a post mounted thereon;
wherein the lead wire is hooked through the slot and secured on the post.

2. The compact fluorescent lamp of claim 1, wherein the lead wire is isolated from the ballast circuit without any insulation.

3. The compact fluorescent lamp of claim 1, further comprising an additional lead wire originating from another cathode of another discharge tube.

4. The compact fluorescent lamp of claim 3, wherein the printed circuit board further includes an additional post for securing the additional lead wire.

5. The compact fluorescent lamp of claim 3, wherein the additional lead wire is hooked through an additional slot included in the collar.

6. The compact fluorescent lamp of claim 3, wherein both lead wires are insulated from one another without any insulation.

7. The compact fluorescent lamp of claim 3, wherein both lead wires are insulated from the ballast circuit without any insulation.

8. The compact fluorescent lamp of claim 1, wherein the collar is made of plastic.

9. The compact fluorescent lamp of claim 3, wherein the posts are made of plastic.

10. The compact fluorescent lamp of claim 1, wherein the other end of the lead wire is connected to a circuit disposed on the printed circuit board.

11. A method of isolating a lead wire connected at one end to a discharge tube disposed in a compact fluorescent lamp, the method comprising:
passing the lead wire through a slot of a collar structure configured to support a printed-circuit board including a post disposed thereon; and
securing the lead wire to the post.

12. The method of claim 11, wherein the securing includes wrapping the lead wire around the post.

13. The method of claim 11, further comprising connecting the other end of the lead wire to a circuit included on the printed circuit board.

14. The method of claim 11, further including passing at least one other lead wire to other slots of the collar structure.

15. The method of claim 14, further including securing the at least one other lead wire to at least one other post disposed on the printed circuit board.

16. A compact fluorescent lamp, comprising
at least two lead wires, each being connected to a respective cathode of a respective discharge tube; and
a ballast circuit;
wherein the at least two lead wires are isolated from one another without any insulation.

17. The compact fluorescent lamp of claim 16, wherein the at least two lead wires are isolated from the ballast circuit without any insulation.

18. The compact fluorescent lamp of claim 16, further comprising a collar including at least two slots.

19. The compact fluorescent lamp of claim 18, wherein a lead wire is passed through one of the slots.

20. The compact fluorescent lamp of claim 19, wherein the lead wire is secured on post disposed on a printed circuit board supporting the ballast circuit, the printed circuit board being mounted on top of the collar.
